(19) United States
(12) Patent Application Publication
(10) Pub. No.: US 2015/0174749 A1
(43) Pub. Date: Jun. 25, 2015

(54) NAIL GUN

(71) Applicant: BASSO INDUSTRY CORP., Taichung (TW)

(72) Inventors: An-Gi LIU, Taichung (TW); Wen-Cheng LO, Taichung (TW)

(21) Appl. No.: 14/575,343

(22) Filed: Dec. 18, 2014

(30) Foreign Application Priority Data
Dec. 25, 2013 (TW) 102148278

(51) Int. Cl. B25C 5/16; B25C 1/00

(52) U.S. Cl. CPC B25C 5/1617; B25C 1/001

(57) ABSTRACT

A nail gun includes a main body defining an axis, a magazine, a connector body connected to the main body and the magazine, a fixed seat connected to one of the magazine and the connector body and having at least one abutment surface configured to abut against a workplace, and a pressing assembly loosenably fixing the fixed seat to the one of the magazine and the connector body. The pressing assembly is operable between a loosened state and a tightened state. When the pressing assembly is in the loosened state, the fixed seat is rotatable relative to the one of the magazine and the connector body such that an angle of the abutment surface of the fixed seat relative to the axis is selectively positionable.

### CROSS REFERENCE TO RELATED APPLICATION

This application claims priority of Taiwanese Application No. 102148278, filed on Dec. 25, 2013.

### FIELD OF THE DISCLOSURE

The disclosure relates to a nail gun, more particularly to a nail gun having an adjustable nail-striking angle.

### BACKGROUND OF THE DISCLOSURE

FIGS. 1 and 2 illustrate a conventional floor nail gun 1 which mainly includes a magazine 12 accommodating a plurality of nails 11, a main body 13 that defines an axis (X), that is connected to the magazine 12 and that sequentially fires the nails 11 in the direction of the axis (X), and a pair of fastening bolts 16 for interchangeably fastening a fixed seat 14 or a fixed seat 15 to the main body 13. The fixed seat 14 has an abutment surface 141 forming an angle of 45 degrees with the axis (X). The fixed seat 15 has an abutment surface 151 forming an angle of 90 degrees with the axis (X).

To nail a workplace (W), the abutment surface 141 of the fixed seat 14 or the abutment surface 151 of the fixed seat 15 is brought to abut against the workpiece (W), so that the nail 11 can penetrate the workpiece (W) at an angle of 45 degrees or 90 degrees along the direction of the axis (X). Through this, adjustment of the nail-striking angle can be achieved.

However, a tool must be used to repeatedly tighten and loosen the fastening bolts 16 during adjustment, of the nail-striking angle, so that use of the conventional floor nail gun 1 is inconvenient, and may affect a smooth adjustment. Further, the two fixed seats 14, 15 must be simultaneously prepared, so that the conventional floor nail gun 1 is not only inconvenient to carry, but also the fixed seats 14, 15 are easy to get lost to thereby cause trouble during use thereof.

### SUMMARY OF THE DISCLOSURE

Therefore, an object of the present disclosure is to provide a nail gun that is capable of overcoming the aforesaid drawbacks of the prior art.

Accordingly, a nail gun of the present disclosure includes a main body unit, a fixed seat and a pressing assembly. The main body unit includes a main body defining an axis, a magazine, and a connector body connected to the main body and the magazine. The fixed seat is connected to one of the magazine and the connector body, and has at least one abutment surface configured to abut against a workplace. The pressing assembly loosenably fixes the fixed seat to the one of the magazine and the connector body, and is operable between a loosened state and a tightened state. When the pressing assembly is in the loosened state, the fixed seat is rotatable relative to the one of the magazine and the connector body such that an angle of the abutment surface of the fixed seat relative to the axis is selectively positionable.

### BRIEF DESCRIPTION OF THE DRAWINGS

Other features and advantages of the present disclosure will become apparent in the following detailed description of the embodiments with reference to the accompanying drawings, of which:

FIG. 1 is a fragmentary schematic view of a conventional floor nail gun, illustrating a nail being driven into a workplace at an angle of 45 degrees;

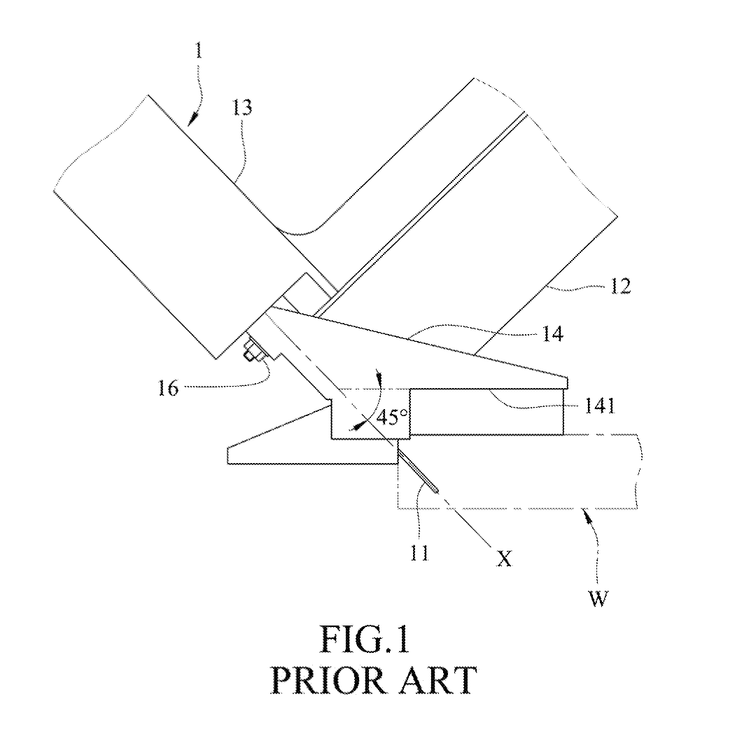

FIG. 2 is another fragmentary schematic view of the conventional nail gun, illustrating the nail being driven into the workplace at an angle of 90 degrees;

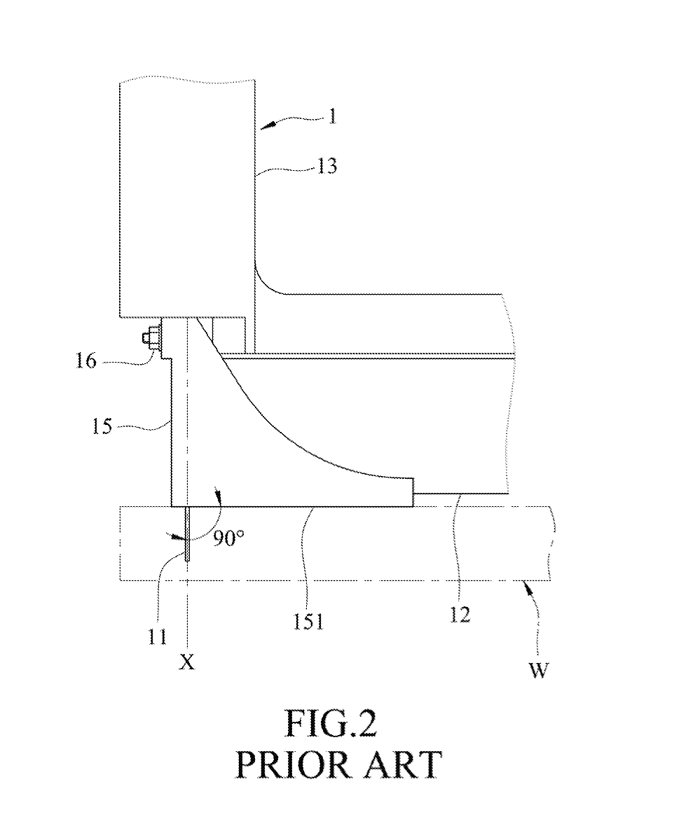

FIG. 3 is a perspective view of a nail gun according to the first embodiment of the present disclosure, but without a main body thereof;

FIG. 4 is an exploded perspective view of a connector body, a fixed seat and a pressing assembly of the first embodiment;

FIG. 5 is an assembled sectional view of the first embodiment, illustrating the pressing assembly in a tightened state;

FIG. 6 is a view similar to FIG. 1, but illustrating the pressing assembly in a loosened state;

FIG. 7 is a partly fragmentary schematic view of the first embodiment, illustrating a nail being driven into a workplace at an angle of 135 degrees;

FIG. 8 is a view similar to FIG. 7, but illustrating a nail being driven into the workplace at an angle of 90 degrees; and

FIG. 9 is a partly fragmentary schematic view of a nail gun according to the second embodiment of the present disclosure.

### DETAILED DESCRIPTION OF THE EMBODIMENTS

Before the present disclosure is described in greater detail with reference to the accompanying embodiments, it should be noted herein that like elements are denoted by the same reference numerals throughout the disclosure.

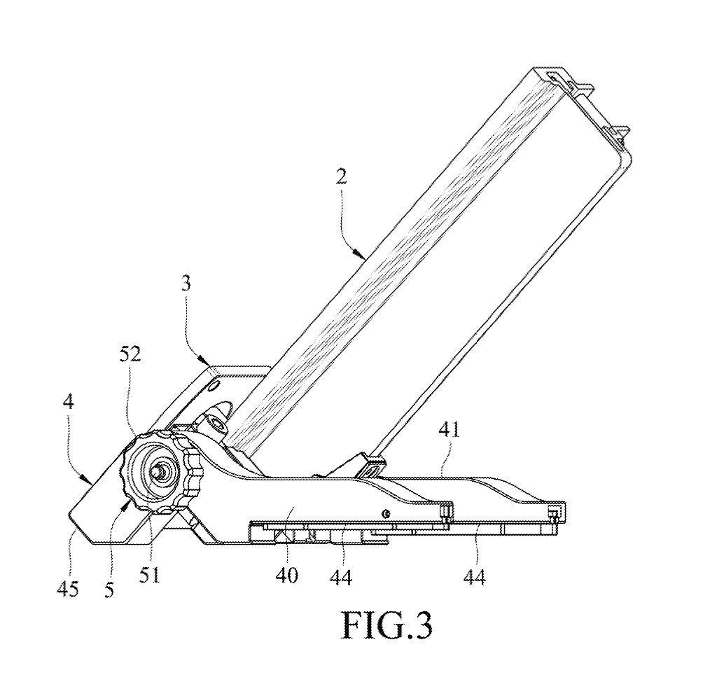

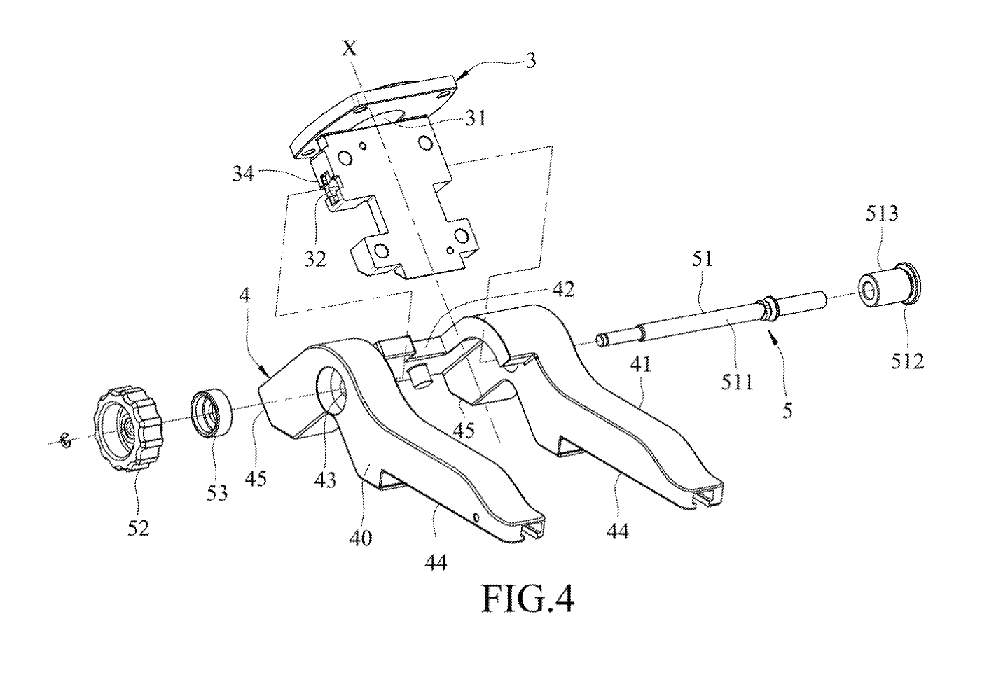

Referring to FIGS. 3 to 8, the first embodiment of a nail gun according to the present disclosure is shown to comprise a main body unit, a fixed seat 4 and a pressing assembly 5.

The main body unit includes a main body 8 defining an axis (X), a magazine 2 accommodating a plurality of nails 21, and a connector body 3 connected to the main body 8 and the magazine 2. The connector body 3 has an opening 31 for extension of a driving piston (not shown) therethrough to sequentially drive the nails 21 in the direction of the axis (X), and a passage hole 32 extending therethrough in a direction transverse to the axis (X). The passage hole 32 has one end formed with a large hole portion 33, and the other end formed with two positioning grooves 34 intersecting each other to form a cross-shaped groove.

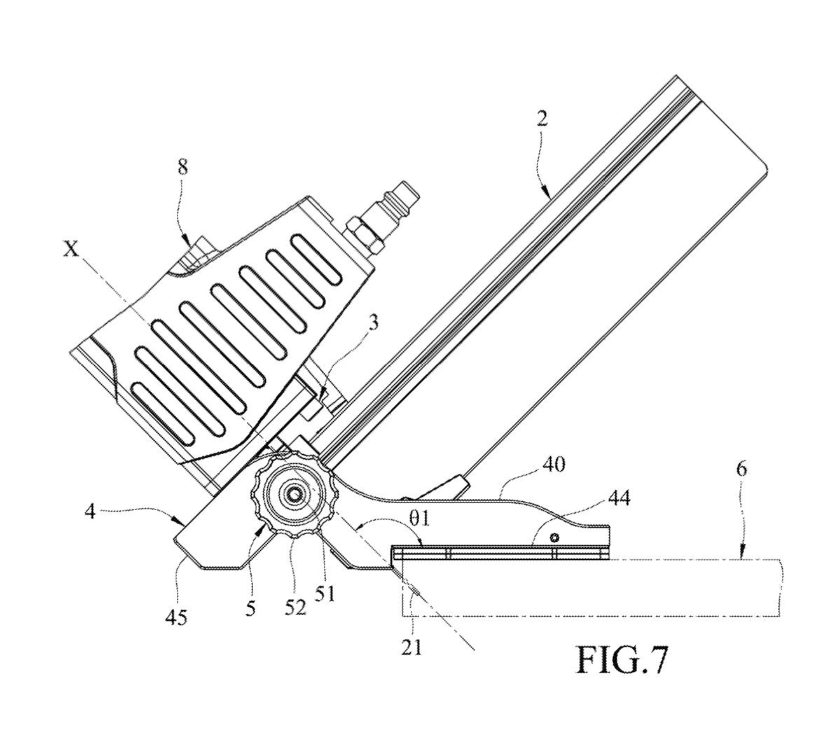

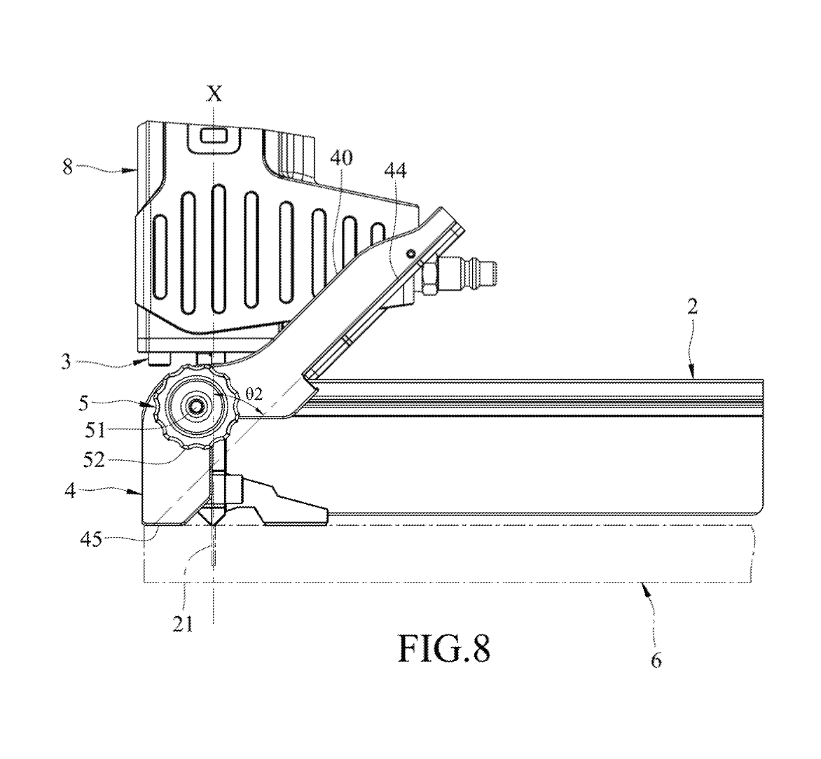

In this embodiment, the fixed seat 4 is connected to the connector body 3, and includes two spaced-apart support members 40, 41, and a bight portion 42 interconnecting the support members 40, 41. Each of the support members 40, 41 has a first abutment surface 44 at one end thereof, a second abutment surface 45 opposite to the first abutment surface 44, and a through hole 43 formed between the first and second abutment surfaces 44, 45 and extending in a direction transverse to the axis (X). The first and second abutment surfaces 44, 45 do not lie in the same plane. The support member 40 further has a protrusion 46 protruding from an inner-side thereof into one of the positioning grooves 34. The fixed seat 4 is rotatable relative to the connector body 3 between a first position (see FIG. 7), in which the first abutment surface 44 forms a first included angle (θ₁) with the axis (X), and a second position (see FIG. 8), in which the first abutment surface 44 forms a second included angle (θ₂) with the axis (X). The first included angle (θ₁) ranges from 125-145 degrees. In this embodiment, the first included angle (θ₁) is 135 degrees. The second included angle (θ₂) is smaller than or equal to 90 degrees. In this embodiment, the second included angle (θ₂) is 45 degrees. The first and second abutment surfaces 44, 45 are spaced apart from each other by an angle equal to the second included angle (θ₂). Moreover, when the fixed seat 4 is in the first position, the first abutment surfaces 44 of the support members 40, 41 face a workpiece 6, and the second abutment surfaces 45 of the support members 40, 41 are distal to the workplace 6. When the fixed seat 4 is in the second position, the second abutment surfaces 45 of the support members 40, 41 face the workplace 6, and the first abutment surfaces 44 of the support members 40, 41 are distal to the workpiece 6.

The pressing assembly 5 includes a bolt member 51, a press member 52 and a gasket 53. The bolt member 51 includes a bolt shank 511 extending through the through holes 43 in the support members 41, 40 and the passage hole 32 in the connector body 3, a tubular sleeve 513 connected to one end of the bolt shank 511 and having a first press surface 512, and a plurality of protruding ribs 514 formed on an outer surface of the bolt shank 511. The first press surface 512 abuts against the support member 41. The protruding ribs 514 are received in and are in frictional contact with the large hole portion 33. The press member 52 in this embodiment is a knob rotatably connected to the other end of the bolt shank 511 and exposed externally of the fixed seat 4. The press member 52 has a second press surface 521 abutting against the support member 40. The gasket 53 is disposed between the support in ember 40 and the press member 52.

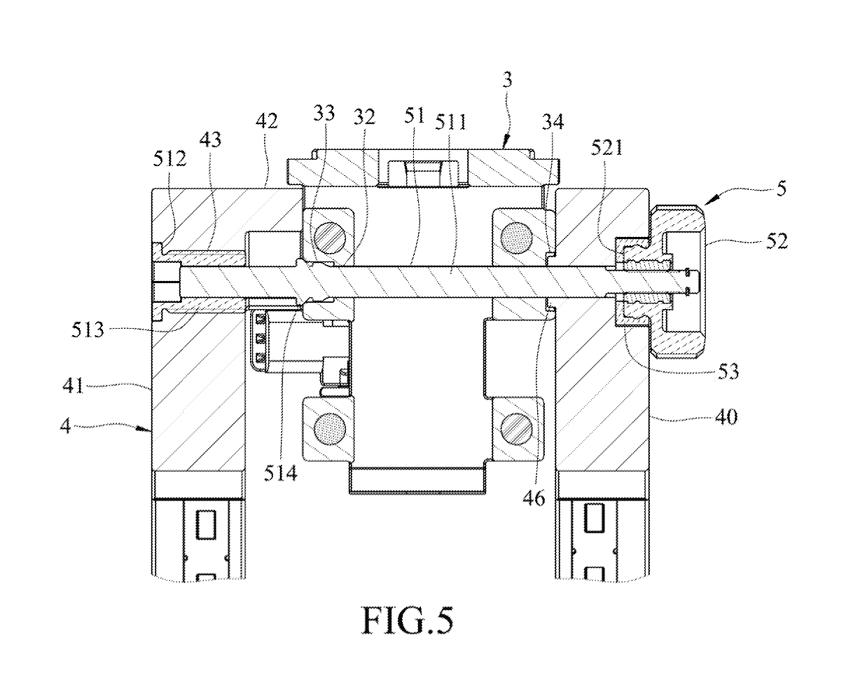

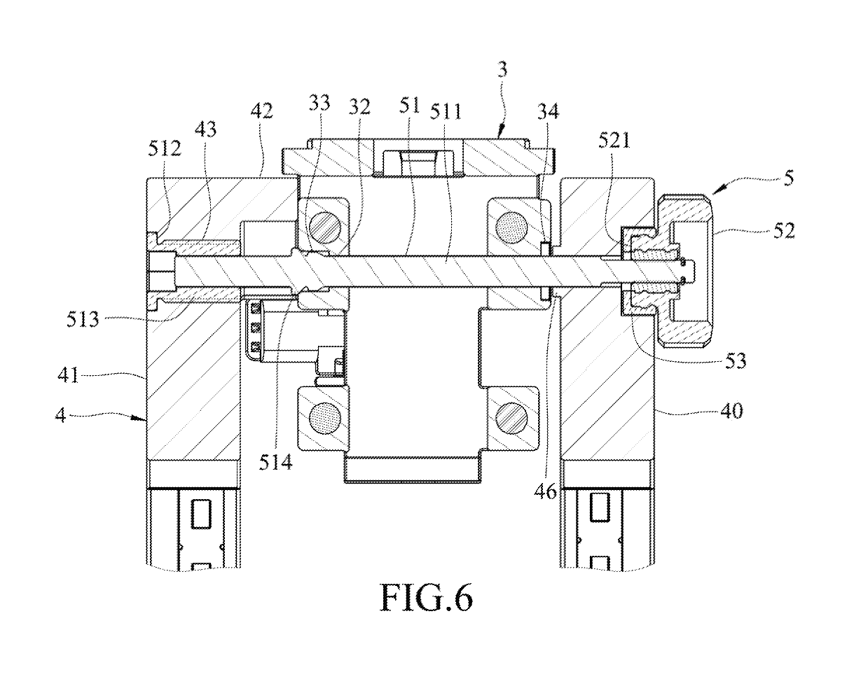

With reference to FIGS. 5 to 8, to adjust a nail-striking angle of the nail gun of this disclosure, the knob or press member 52 is first rotated to move slightly out of the bolt shank 511 to a loosened state (see FIG. 6), so that the first and second press surfaces 512, 521 loosely abut against the respective support members 41, 40. The fixed seat 4 can then be rotated about the bolt member 51 to the first position (see FIG. 7) or the second position (see FIG. 8) relative to the connector body 3. Afterwards, the press member 52 is reversely rotated to move inward of the bolt shank 511 to a tightened state (see FIG. 5), so that the first and second press surfaces 512, 521 tightly abut against the respective support members 41, 40. Further, the gasket 53 can push the support member 40 to engage the protrusion 46 with one of the positioning grooves 34 so as to limit the support member 40. As such, the support members 41, 40 are tightly pressed against the connector body 3 so that the fixed seat 4 is stably fixed to the connector body 3.

With reference to FIGS. 7 and 8, to nail the workpiece 6, the first abutment surfaces 44 or the second abutment surfaces 45 of the support members 40, 41 are brought to abut against the workplace 6, after which the nail 21 is driven into the workplace 6 along the axis (X) at an angle of 45 degrees or 90 degrees.

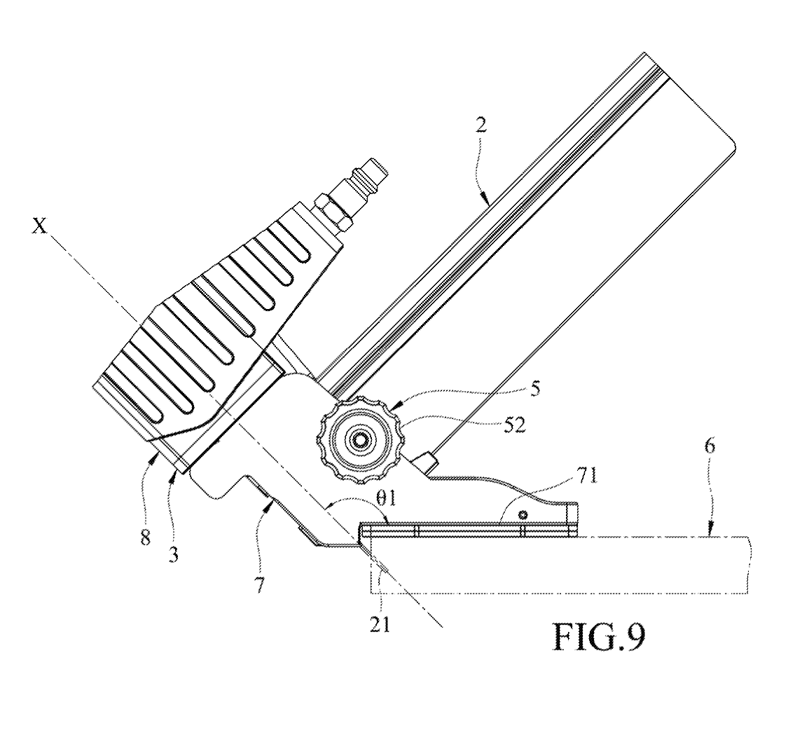

Referring to FIG. 9, the second embodiment of a nail grin according to the present disclosure is shown to be similar to the first embodiment. Particularly, the nail gun comprises a main body unit, a fixed seat 7 and a pressing assembly 5. The main body unit includes a main body 3, a magazine 2 and a connector body 3 connected to the magazine 2. However, in this embodiment, the fixed seat 7 is connected to the magazine 2, and has at least one abutment surface 71 at one end thereof. The bolt member 51 of the pressing assembly 5 extends through the fixed seat 7 and the magazine 2 so as to interconnect the fixed seat 7 and the magazine 2, When the press member 52 of the pressing assembly 5 is rotated to move to the loosened state, the fixed seat 7 is rot a table relative to the magazine 2 such that an angle of the abutment surface 71 relative to the axis (X) is selectively positionable. In this embodiment, the abutment surface 71 is exemplified to form the included angle (θ₁) with the axis (X). The press member 52 is then moved to the tightened state after the desired position of the abutment surface 71 is obtained.

In sum, the nail gun of the present disclosure uses the pressing assembly 5 to loosenably fix the fixed seat 4 to the connector body 3 or the magazine 2, so that the fixed seat 4 can he rotated relative to the connector body 3 or the magazine 2. Through this, the angle of the first or second abutment surface 44, 45 or the abutment surface 71 relative to the axis (X) is selectively positionable, thereby achieving the purpose of adjusting the nail-striking angle of the nail gun of this disclosure without using any tool. Additionally, it is only necessary to prepare the fixed seat 4, so that the replacement process of the conventional nail gun may be omitted. Hence, adjustment of the nail-striking angle of this disclosure can be facilitated, and practicability during nail-striking can be enhanced.

While the present disclosure has been described in connection with what are considered the most practical embodiments, it is understood that this disclosure is not limited to the disclosed embodiments but is intended to cover various arrangements included within the spirit, and scope of the broadest interpretation so as to encompass all such modifications and equivalent arrangements.

What is claimed is:

1. A nail gun, comprising;
a main body unit including a main body defining an axis, a magazine, and a connector body connected to said main body and said magazine;
a fixed seat connected to one of said magazine and said connector body, said fixed seat having at least one abutment surface configured to abut against a workplace; and
a pressing assembly loosenably fixing said fixed seat to said one of said magazine and said connector body, said pressing assembly being operable between a loosened state and a tightened state;
wherein, when said pressing assembly is in the loosened state, said fixed seat is rotatable relative to said one of said magazine and said connector body such that, an angle of said abutment surface of said fixed seat relative to the axis is selectively positionable.

2. The nail gun as claimed in claim 1, wherein:
said fixed seat is connected, to said connector body, and has at least one first abutment surface formed at one end thereof, and at least one second abutment surface formed at the other end thereof;
when said pressing assembly is in the loosened state, said fixed seat is rotatable relative to said connector body between a first position, in which said first abutment surface forms a first included angle with the axis, and a second position, in which said first abutment surface forms a second included angle with the axis;
said first and second abutment surfaces are spaced apart from, each other by an angle equal to said second included angle;
when said fixed seat is in the first position, said first abutment surface is configured to face the workpiece, and the second abutment surface is configured to be distal to the workpiece and
when said fixed seat is in the second position, said first abutment surface is configured to be distal to the workpiece, and the second abutment surface is configured to face the workpiece.

3. The nail gun as claimed in claim 2, wherein said first included angle ranges from 125-145 degrees, and said second included, angle is smaller than or equal to 90 degrees.

4. The nail gun as claimed in claim 1, wherein said fixed seat is connected to said magazine, said fixed seat being rotatable relative to said magazine when said pressing assembly is in the loosened state to selectively position the angle of said at least one abutment surface relative to the axis.

5. The nail gun as claimed in claim 1, wherein said pressing assembly includes a bolt member extending through said fixed seat and said one of said magazine and said connector body along a direction transverse to the axis, and a press member movably connected to one end of said bolt member, said bolt member having a first press surface abutting against one side of said fixed seat, said press member having a second press surface abutting against the other side of said fixed seat.

6. The nail gun as claimed in claim 5, wherein said press member is configured as a knob rotatably connected to said one end of said bolt member and exposed externally of said fixed seat.

7. The nail gun as claimed in claim 6, wherein said bolt member includes a bolt shank, and a tubular sleeve connected to said bolt shank opposite to said press member and having said first press surface.

8. The nail gun as claimed in claim 5, wherein said fixed seat includes two support members, and a bight portion interconnecting said support members, each of said support members having said abutment surface, and a through hole extending in a direction transverse to the axis.

9. The nail gun as claimed in claim 8, wherein said connector body has a passage hole for extension of said bolt member therethrough, said passage hole having one end formed with a large hole portion, and the other end formed with two positioning grooves intersecting each other to form a cross-shaped groove, said bolt member further having a plurality of protruding ribs formed on an outer surface thereof, said protruding ribs being received in and being in frictional contact with said large hole portion, one of said support members further having a protrusion protruding from an inner side thereof into one of said positioning grooves.
